(19) United States
(12) Patent Application Publication
(10) Pub. No.: US 2005/0216398 A1
(43) Pub. Date: Sep. 29, 2005

(54) System and method for international funds transfer and access

(76) Inventors: Ryan T. Powers, Smyrna, GA (US); Geoff Toffetti, Orlando, FL (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/812,196

(22) Filed: Mar. 29, 2004

(51) Int. Cl. G06F 17/60

(52) U.S. Cl. 705/39

(57) ABSTRACT

A system and method of international funds transfer and access, wherein the present invention provides for the automated and regular deduction of a pre-selected amount or percentage of a sender's income over a selected pay period for subsequent automated remittance of same to a designated foreign receiving party; thus, absolving the sender and receiving party of any pro-active responsibilities typically associated with implementing the funds transfer process through conventional funds transfer services.

### TECHNICAL FIELD

The present invention relates generally to methods of transferring funds, and more specifically to a system and method of international funds transfer and access, wherein the present invention is particularly advantageous for its ability to eliminate the inconvenience and delays commonly associated with conventional money transfer services requiring the sender to travel to an agent location or other physical retail location to implement the money transfer transaction.

### BACKGROUND OF THE INVENTION

Each year, millions of work-authorized immigrants, permanent residents, and/or naturalized citizens send regular portions or installments of their income to family, friends and/or loved-one residing in a foreign country. Most often, the process utilized to transmit such funds is a money transfer service. Unfortunately, however, many available money transfer services and associated methods of funds transfer possess inherent disadvantages that render use and implementation of same highly inconvenient, burdensome, overly complex and inefficient.

Specifically, conventional money or funds transfer service entities typically require a sender initiate the process by visiting one of often many physical locations or satellite offices usually located within heavily-trafficked public facilities, such as a grocery stores, airports, mail box centers, post offices, currency exchange offices, and the like. The sender must typically complete a sender's transaction form, designating the amount of funds being transferred, the desired destination of transfer (i.e., foreign country), and information pertinent to the receiving party. Thereafter, the sender must pay the agent on-site the cash equivalent of the transfer amount, in addition to a transaction fee, before the agent will process the transaction.

To retrieve the transferred funds at the destination point, the receiving party is required to travel to a foreign office associated with the funds transfer service entity, which is also usually located within a common public facility. Upon arrival, the receiving party must complete a receiver's transaction form, typically designating the name of the receiving party, relevant contact information of the sender and receiving party, the expected amount of funds, and further information regarding the origination of the funds. Additionally, the receiving party must supply the foreign agent on-site with acceptable identification that often must meet government requirements of the sender's country/origin—usually a Drivers License or current passport, and/or provide the agent with the correct password or answer to a test question provided by the sender for security measures. Thereafter, the agent on site remits to the receiving party the foreign currency cash equivalent of the transferred amount.

Although service entities utilizing the above-discussed method of funds transfer provide the sender/customer with an avenue for remitting funds to international receiving parties, such a method is seemingly unnecessarily convoluted and unduly burdensome. Specifically, for those individuals remitting regular portions or installments of their income to a designated international receiving party, equally regular visits must be made to a physical retail location to implement the money transfer transaction; thus, presenting a relatively time-consuming and inconvenient process, especially in view of the paperwork associated therewith. Unfortunately, the receiving party is subject to similar inconveniences, as the party must equally as frequently travel to an associated foreign-based physical retail location to complete the requisite paperwork and provide the appropriate identification prior to receipt of the funds. Moreover, because many such physical retail locations are located within highly populated areas, parties involved in the funds transfer process are typically exposed to the inherently high crime environment notoriously pervasive through such highly populated areas; thus, subjecting the parties carrying hard currency to potential robbery, assault, and/or murder.

Additionally, customers/senders utilizing the aforementioned funds transfer method must further be concerned with the proximity of an associated foreign-based physical retail location relative to the receiving party. That is, because the associated foreign-based physical retail location is likely located within a major city or other highly-populated geographic region of the foreign country, a deeply rural-based receiving party may be forced to travel a significant distance to an associated foreign-based physical retail location, or authorized agency, to retrieve the transferred funds. Obviously, such regular, long-distance journeys impart significant burden and potential expense unto the receiving party.

Yet still another disadvantage associated with such a method is the potential absence or non-existence of an associated foreign-based physical retail location in the country or city within which the receiving party resides; thereby potentially precluding the transfer of funds via such a method, and, thus, forcing the sender to resort to lengthy conventional airmail or parcel delivery services—a somewhat risky method considering the contents of the mailing.

A further disadvantage associated with such conventional funds transfer services is that upon providing the service agent with the remittance funds, the sender relinquishes all control over the remitted funds; thus, severing the sender's ability to recapture the funds and/or apportion the receiving party's access thereto.

An additional concern with the utilization of such a method is the sender's dependency upon the hours of operation of such service entities. That is, the sender's ability to transfer funds is solely dependent on whether the physical retail location offering such funds transfer services is open for business; thus, dictating the times at which a transfer may be made, and, as such, forcing the sender to either re-organize his/her work schedule, if possible, to transfer funds during the entity's business hours, or delay sending the much-needed funds until he/she is able to locate a service entity with business hours amenable with the sender's schedule.

Although “online” or global networking system services (i.e., Internet or the like) offer the electronic transfer or wiring of funds, utilization of such online funds transfer services is wholly dependent upon the sender's accessibility to a global networking system, let alone a computer, and upon the existence of a foreign bank account in the receiving party's name—the latter being particularly difficult when the foreign receiving party is a relatively lower-income and/or poverty stricken family. However, even if the sender has access to an Internet-equipped computer, and assuming the existence of a foreign bank account into which money may be wired, the sender, if not Internet-savvy, is faced with the complexities of navigating through a potentially complex online funds transfer process—a process that can become particularly time-consuming if performed on a regular basis.

Unfortunately, even if the sender utilizes personal banking services to effectuate an electronic transfer/wire of funds, the sender must still pay regular physical visits or calls to his/her banking institution to implement the money transfer transaction and provide the agent on-site with the requisite authorization to process the transaction.

Therefore, it is readily apparent that there is a need for a system and method of international funds transfer and access, that may eliminate the inconvenience and delays commonly associated with conventional money transfer services requiring the sender and receiving party to travel to remote physical locations to participate in the funds transfer transaction, and, instead, alleviates the sender of any duty or regular obligation to initiate the funds transfer process and/or utilize online funds transfer services to effectuate the transfer, and which further enables the receiving party to receive the funds free of any obligation to hold and maintain an active bank account.

### BRIEF SUMMARY OF THE INVENTION

Briefly described, in a preferred embodiment, the present invention overcomes the above-mentioned disadvantages and meets the recognized need for such a method by providing a system and method of international funds transfer and access, wherein the present invention provides for the automated and regular deduction of a pre-selected amount or percentage of a sender's income over a selected pay period for subsequent automated remittance of same to a designated foreign receiving party; thus, absolving the sender and receiving party of any pro-active responsibilities typically associated with implementing the funds transfer process through conventional funds transfer services.

According to its major aspects and broadly stated, the present invention in its preferred form is a system and method of international funds transfer and access, comprising, in general, a debit card and deposit account issuance process, a funds deduction process, a transaction fee deduction process, a funds transfer and remittance process, and a debit card activation process.

More specifically, the present invention is a system and method of international funds transfer and access, wherein a sender and a designated foreign receiving party are each preferably issued a non-activated debit card by a funds transfer service entity. As more fully described below, the non-activated debit cards preferably provide the sender and receiving party with access to an associated deposit account.

Preferably, a pre-determined amount or percentage of the sender's post-tax income over a selected period (i.e., weekly, bi-monthly, quarterly, biannually, or the like) is regularly and directly deducted from the sender's paycheck, and subsequently deposited into an escrow account. A transaction fee is preferably deducted from the escrowed funds by the service entity, wherein the remaining funds are preferably transferred into the afore-referenced deposit account. Thereafter, the sender may selectively remit the funds to the receiving party by activating the previously issued debit cards; thereby, enabling the receiving party to draw funds from the deposit account, and further providing the sender with selective access thereto.

Accordingly, a feature and advantage of the present invention is its ability to provide for the automated and regular deduction of a pre-selected amount or percentage of a sender's income over a selected pay period for subsequent automated remittance of same to a designated foreign receiving party.

Another feature and advantage of the present invention is its direct deduction of the remittance funds from the sender's paycheck.

Still another feature and advantage of the present invention is its incorporation and utilization of debit cards to effectuate access to the remitted funds.

Yet another feature and advantage of the present invention is its ability to eliminate the inconveniences and delays commonly associated with conventional money transfer services requiring the sender and receiving party to travel to remote physical locations to participate in the funds transfer transaction.

Still yet another feature and advantage of the present invention is its ability to alleviate the sender of any duty or regular obligation to initiate the funds transfer process.

A further feature and advantage of the present invention is its ability to provide the receiving party with access to the remitted funds free of any obligation to hold an active bank account, wherein the receiving party is afforded such access via conventional debits cards, credits cards, automated teller machines, point-of-sale retail locations, and the like.

Still a further feature and advantage of the present invention is its ability to provide the sender with complete control over the remitted funds; thus, enabling the sender to recapture the funds and/or apportion the receiving party's access thereto.

Still yet a further feature and advantage of the present invention is that the sender and receiving party may avoid carrying hard currency into and/or out of high crime environments typically associated with highly populated areas.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 illustrates a flow diagram of a system and method of international remittance funds transfer and access according to a preferred embodiment of the present invention.

### DETAILED DESCRIPTION OF THE PREFERRED AND SELECTED ALTERNATIVE EMBODIMENTS

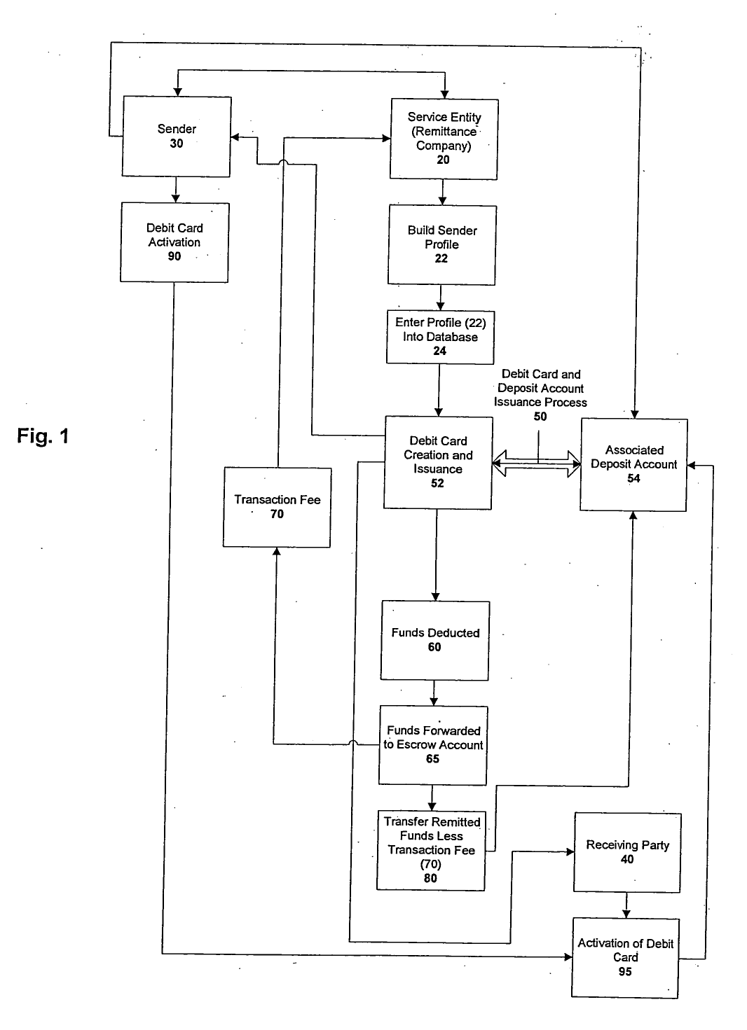

In describing the preferred and selected alternate embodiments of the present invention, as illustrated in FIG. 1, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in a preferred embodiment is a system and method 10 of international funds transfer and access, wherein system and method 10 preferably comprises service entity 20, sender 30, receiving party 40, debit card and deposit account issuance process 50, funds deduction process 60, transaction fee deduction process 70, funds transfer and remittance process 80, and debit card activation process 90.

Service entity 20 is preferably any suitable financial management entity and/or financial service entity adapted to provide sender 30 with system and method 10 as a regular financial service, wherein service entity 20 may include, without limitation, accounting firms, dedicated payroll service companies, financial solutions companies, financial management companies, funds transfer companies, brokerage firms, banks, financial institutions, and the like.

More specifically, service entity 20 preferably provides sender 30 with system and method 10 as a financial service through the employer of sender 30. Accordingly, should sender 30 express to his/her employer an interest in remitting funds internationally to receiving party 40, or if sender regularly and currently utilizes a conventional funds transfer service to process international remittances, sender 30 may request through his/her employer enrollment into the service program of service entity 20, and, thus, avoid the inconveniences commonly associated with traditional funds transfer services that might otherwise require sender 30 to travel to a remote physical retail location to implement the funds transfer process. Alternatively, if sender 30 is self-employed and utilizes service entity 20 for existing financial management services, including payroll processing services, sender 30 may directly request service entity 20 to enroll sender 30 into system and method 10.

Enrollment within system and method 10 preferably entails service entity 20 establishing a sender account or profile 22 within service entity database 24 customized for each sender 30 requesting enrollment within system and method 10, wherein profile 22 may detail, without limitation, the name of sender 30, sender's 30 employer name and tax identification number, sender's 30 social security number, applicable address and contact information, a remittance deduction code or identification number specific to sender 30 and/or his/her employer, and the like. Most notably, profile 22 further preferably includes detailed payroll information specific to sender 30 and/or his/her employer, including payroll processing dates, pay dates, and the requested remittance amount to be regularly deducted from sender's 30 post-tax income over a selected pay period (i.e., weekly, bi-monthly, quarterly, biannually, or the like), and subsequently remitted to receiving party 40 according to system and method 10, as more fully described below. It should be recognized that the remittance amount to be regularly deducted from sender's 30 post-tax income may be any pre-determined amount or percentage thereof so selected by sender 30, and may further be increased and/or decreased at the request of sender 30.

Following completion of profile 22, debit card and deposit account issuance process 50 ensues, wherein service entity 20 preferably mails, sends or otherwise issues non-activated debit or remittance cards 52 to sender 30 and receiving party 40, or, alternatively, to sender 30 for his/her subsequent selective dispersal of same to a designated receiving party 40. Preferably, and for purposes more fully described below, remittance cards 52 provide sender 30 and receiving party 40 with access to an associated deposit account 54, preferably established by service entity 20 during entry or construction of sender profile 22 within database 24.

In accordance with the specific remittance/deduction information and payroll processing and pay date information within sender profile 22, funds deduction process 60, preferably implemented by and through service entity 20 during regular payroll processing of sender's 30 gross income for a selected pay period, specifically entails the regular deduction of a pre-selected remittance amount, in addition to a transaction service fee, from sender's 30 post-tax paycheck for subsequent deposit of same into escrow account 65.

Following deposit of the deducted funds into escrow account 65, transaction fee deduction process 70 preferably involves service entity 20 deducting and receiving the service transaction fee as payment for facilitating the international remittance funds transfer process of system and method 10 for sender 30. Thereafter, the remainder of deducted funds is preferably remitted or transferred 80 into the afore-referenced deposit account 54 for subsequent access to same by sender 30 and receiving party 40, as more fully described below.

Preferably, funds transferred into deposit account 54 are made available to sender 30 and/or receiving party 40 on sender's 30 scheduled pay date, pursuant to sender profile 22 within service entity database 24.

Thereafter, funds within deposit account are preferably accessible by sender 30 and receiving party 40 following remittance card activation process 90. That is, sender 30 may selectively remit or make available to receiving party 40 those funds within deposit account 54 by activating his/her previously issued remittance card 52. Activation of sender's 30 remittance card 52 preferably results in activation 95 of receiving party's 40 remittance card 52, thereby enabling receiving party 40 to draw funds from deposit account 54, and further providing sender 30 with selective access thereto. Preferably, sender 30 activates remittance cards 52 via telephonic entry of a security code, identification number, or account number—similar to conventional credit card activation processes, thereby providing receiving party 40 with unfettered access to deposit account 54. However, sender 30 may selectively restrict or preclude receiving party's 40 access to deposit account 54 by similar telephonic entry of deactivation or account restriction codes. As such, the present invention notably provides sender 30 with complete control over the remitted funds; thus, enabling sender 30 to recapture the funds and/or apportion receiving party's 40 access thereto. Although the present invention contemplates telephonic activation/deactivation of remittance cards 52, it should be recognized that any suitable activation/deactivation process and/or technology may be utilized such as, for exemplary purposes only, automatic activation of remittance cards 52 and deposit account 54 on the pay date of sender 30, activation/deactivation of remittance cards 52 and deposit account 54 by service entity 20 at pre-selected schedules, or sender-implemented processes including, without limitation, activation/deactivation through a global networking system, activation/deactivation via scanning technology at automated teller machines, or the like.

As such, the present system and method 10 advantageously provides for the automated and regular deduction of a pre-selected amount or percentage of sender's 30 gross income over a selected pay period for subsequent automated remittance of same to receiving party 40, thereby eliminating the inconveniences and delays commonly associated with conventional money transfer services that would otherwise require sender 30 and receiving party 40 to travel to remote physical locations to participate in the funds transfer transaction. Additionally, in view of the direct deduction of the selected remittance amount from sender's 30 paycheck, sender 30 is free from regular obligation to initiate the funds transfer process.

Although the present system and method 10 contemplates remittance of funds via deposit account 54 and associated remittance cards 52, it should be recognized that other suitable financial vehicle could be utilized to remit, convey or otherwise transfer a desired amount of funds to receiving party 40, wherein such alternate financial vehicles may include, without limitation, hard currency, cash cards, smart cards, checks, other negotiable and/or non-negotiable instruments, foreign retirement accounts, foreign stock markets, foreign mutual funds, certificates, bonds, foreign personal accounts, foreign business accounts, and/or the like.

It should further be recognized that system and method 10 is not limited to international funds remittance applications and foreign receiving parties alone, but may be equally utilized to effectuate national funds remittances to nationally-based receiving parties (i.e., receiving parties 40 residing within the same nation as sender 30).

Additionally, the present invention contemplates that sender 30 may designate a plurality of receiving parties 40 to which a pre-determined amount of funds is to be transferred via the system and method 10, wherein an equivalent number of remittance cards 54 may be dispersed to the applicable receiving parties, and wherein each such remittance card 54 may provide access to a common or shared deposit account 54, or, alternatively, separate deposit accounts 54. With respect to a common or shared deposit account 54, access of each remittance card 52 thereto may be appropriately restricted based upon the amount or percentage of deposited funds to be remitted to respective receiving parties 40.

The present invention further contemplates that, upon sender's 30 authorization, service entity 20 may coordinate with sender's 30 banking institution to implement the present system and method 10. In such an embodiment, sender 30 may authorize service entity 20 to regularly withdraw a pre-selected amount of funds from sender's 30 account, for subsequent remittance of same to receiving party 40 according to the above-described system and method 10. Such an embodiment further contemplates that service entity 20 would extract its service transaction fee from sender's 30 bank account, as payment for providing the remittance service.

Furthermore, although the present invention contemplates that the remittance funds be deducted from sender's 30 post-tax income, it should be recognized that the remittance funds could be deducted from sender's 30 pre-tax income so as to enable sender 30 to receive tax deductions, in accordance with State and Federal regulations and/or legislation, for remittance of the funds to receiving party 40 and/or associated individual retirement accounts, and the like.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A method of remittance funds transfer, said method comprising the steps of:
a. deducting a remittance amount from a first party's income over a selected pay period; and,
b. providing a receiving party with access to at least a portion of the remittance amount.

2. The method of claim 1, wherein said step of providing a receiving party with access to the remittance amount comprises the step of issuing debit cards to the first party and the receiving party.

3. The method of claim 2, wherein said debit cards provide the first party and the receiving party with access to an associated deposit account.

4. The method of claim 3, wherein the remittance amount deducted from the first party's income includes a transaction fee.

5. The method of claim 4, further comprising the step of c.: transferring the remittance amount and transaction fee deducted from the first party's income to an escrow account.

6. The method of claim 5, further comprising the step of d.: extracting from said escrow account the transaction fee.

7. The method of claim 6, further comprising the step of e.: transferring the remittance amount from said escrow account to said deposit account.

8. The method of claim 7, further comprising the step of f.: activating said debit cards to provide the receiving party and the sender with access to the remittance amount in said deposit account.

9. The method of claim 1, wherein the receiving party resides internationally with respect to the domicile of the first party.

10. The method of claim 1, wherein said step of providing a receiving party with access to the remittance amount comprises a financial vehicle selected from the group consisting of remittance cards, debit cards, cash cards, smart cards, hard currency, checks, negotiable instruments, non-negotiable instruments, retirement accounts, stock market funds, mutual funds, certificates, bonds, personal accounts, business accounts, and combinations thereof.

11. A method of remittance funds transfer, said method comprising the steps of:
a. deducting on a regular basis a remittance amount from a first party's income over selected pay periods; and,
b. remitting the remittance amount to a receiving party via a financial vehicle, said financial vehicle selected from the group consisting of remittance cards, debit cards, cash cards, smart cards, hard currency, checks, negotiable instruments, non-negotiable instruments, retirement accounts, stock market funds, mutual funds, certificates, bonds, personal accounts, business accounts, and combinations thereof.

12. A system and method of remittance funds transfer, comprising:
a. a sender;
b. a receiving party;
c. a service entity providing remittance funds transfer services to said sender through said sender's employer;
d. a step of deducting a remittance amount from said sender's income over a selected pay period; and,
e. a step of providing said receiving party with access to the remittance amount.

13. The system and method of claim 12, wherein said step of providing said receiving party with access to the remittance amount comprises the step of issuing debit cards to said sender and said receiving party.

14. The method of claim 13, wherein said debit cards provide said sender and said receiving party with access to an associated deposit account.

15. The method of claim 14, wherein the remittance amount deducted from said sender's income includes a transaction fee.

16. The method of claim 15, further comprising the step of transferring the remittance amount and transaction fee deducted from the sender's income to an escrow account.

17. The method of claim 16, further comprising the step of extracting from said escrow account the transaction fee.

18. The method of claim 17, further comprising the step of transferring the remittance amount from said escrow account to said deposit account.

19. The method of claim 18, further comprising the step of activating said debit cards to provide said receiving party and said sender with access to the remittance amount in said deposit account.

20. The method of claim 12, wherein said receiving party resides internationally with respect to the domicile of said sender.

21. The method of claim 12, wherein said step of providing said receiving party with access to the remittance amount comprises a financial vehicle selected from the group consisting of remittance cards, debit cards, cash cards, smart cards, hard currency, checks, negotiable instruments, non-negotiable instruments, retirement accounts, stock market funds, mutual funds, certificates, bonds, personal accounts, business accounts, and combinations thereof.

22. A system and method of remittance funds transfer, comprising:
a. a sender;
b. a receiving party;
c. a service entity providing remittance funds transfer services to said sender through said sender's banking institution;
d. a step of deducting a remittance amount from said sender's bank account with the banking institution over a selected period; and,
e. a step of providing said receiving party with access to the remittance amount.

23. A method of remittance funds transfer, said method comprising the steps of:
a. deducting on a regular basis a remittance amount from a first party's income over selected pay periods; and,
b. providing a receiving party with access to at least a portion of the remittance amount.
